(19) United States
(12) Patent Application Publication
(10) Pub. No.: US 2013/0206537 A1
(43) Pub. Date: Aug. 15, 2013

(54) PRESSURE-MEDIUM ACTUATED FRICTION CLUTCH OR FRICTION BRAKE

(71) Applicants: Matthias Glomm, Iserlohn (DE); Rainer Bittermann, Bergkamen (DE); Thomas Haeseker, Lauterhofen (DE)

(72) Inventors: Matthias Glomm, Iserlohn (DE); Rainer Bittermann, Bergkamen (DE); Thomas Haeseker, Lauterhofen (DE)

(21) Appl. No.: 13/880,293

(22) PCT Filed: Oct. 20, 2011
(86) PCT No.: PCT/EP11/68301

§ 371 Date: Apr. 18, 2013

(30) Foreign Application Priority Data
Oct. 20, 2010 (DE) 10 2010 049 811.4

(51) Int. Cl. F16D 13/58

(52) U.S. Cl. CPC F16D 13/583
USPC 192/85.03

(57) ABSTRACT

A friction clutch or brake having an axially movable pressure piston arrangement and at least one annular shoulder, to which pressure can be applied by the pressure piston arrangement. The pressure piston arrangement has at least two pistons, which can be applied to the at least one annular shoulder in succession and in stages in a pressure-dependent manner.

The invention relates to a pressure-medium actuated friction clutch or brake having an axially movable pressure piston arrangement and at least one friction disk, to which pressure can be applied by the pressure piston arrangement.

A friction clutch of this kind, the KHM 800/4 made by Stromag AG, is known. As a pressure piston arrangement, the known friction clutch has a pressure piston which acts on two friction disks of an output-side clutch hub. The friction clutch is hydraulically actuated. For this purpose, the pressure piston is assigned a pressure space within a clutch housing, to which hydraulic oil can be supplied. Hydraulic actuation leads to an axial movement of the pressure piston and hence to frictional engagement with the friction disks, thereby achieving the desired torque transmission.

It is the object of the invention to provide a friction clutch or brake of the type stated at the outset which allows a smooth operating process.

This object is achieved by virtue of the fact that the pressure piston arrangement has at least two pistons, which can be applied to the at least one friction disk in succession and in stages in a pressure-dependent manner. The pistons of the pressure piston arrangement are thus arranged in series, since one piston acts on the at least one friction disk first, and then the at least one second piston is engaged to provide a supplementary action on the at least one friction disk. This makes it possible to achieve a smooth operating process for the clutch or brake. This is because the engagement of the first piston entails activation of the clutch or brake with a relatively low torque. The engagement of the second piston then brings about a graduated increase in torque. The solution according to the invention is particularly suitable for the smooth engagement of drives in industrial or agricultural machines. The solution according to the invention is particularly suitable for the engagement of a main drive in a combine harvester. The smooth engagement ensures that there is only a slight dip in the speed of a diesel engine supplying power to the main drive. Stalling of the diesel engine during a clutch operating process is reliably avoided. Relatively rapid engagement of the drive is made possible. As a particularly advantageous option, mechanical means are provided in order to achieve the multi-stage operating characteristic of the clutch or brake.

As a development of the invention, the piston is assigned a common pressure space for the application of pressure medium, and at least one piston is assigned a retention means which applies a counterforce and defines a higher pressure level for an axial movement of the piston than for the at least one other piston. The at least two pistons are preferably arranged coaxially with one another. Since the pistons have a common pressure space for the application of pressure medium, they define a common piston end face, which is definitive for calculation of the pressure.

As a development of the invention, at least one mechanical spring arrangement, which acts on the piston, is provided as the retention means. The spring arrangement acts as a counterforce during application of pressure to the piston, and therefore the pressure acting on the piston must exceed the counterforce of the spring arrangement in order to be able to move the piston.

As a further development of the invention, the retention means comprises a piston bearing with a friction coefficient which is higher than that of a bearing for the at least one other piston. Here, the increased friction coefficient of the bearing acts as a counterforce, with the same result as that in the embodiment described above. This is because the piston can be moved only after overcoming the increased friction force.

As a further development of the invention, the spring arrangement has a plurality of helical compression springs, which are arranged in a manner distributed over a clutch or brake circumference and engage, on the one hand, on a clutch or brake housing and, on the other hand, on a piston end face remote from the pressure space. Depending on the available installation space, it is possible to arrange different helical compression springs offset radially and in the circumferential direction relative to one another.

As a further development of the invention, the piston arrangement is formed by a pair of pistons comprising an inner piston and an annular outer piston radially surrounding the inner piston, wherein the inner piston is mounted slidably in the outer piston. A double piston is thereby formed, wherein, initially, one of the two pistons can be moved at a lower pressure level. When the pressure level is increased, the second piston is also displaced in addition. The engagement behavior according to the invention provides a large degree of insensitivity to pressure fluctuations within an associated hydraulic system. According to the invention, the graduated engagement process is furthermore independent of a viscosity of the pressure medium and hence of the operating medium.

As a further development of the invention, a sliding bearing is provided between the outer piston and the inner piston, comprising a nonmetallic annular sliding-contact strip. The annular sliding-contact strip is preferably composed of PTFE (polytetrafluoroethylene). The additional annular sliding-contact strip allows nonmetallic support for the inner piston in the outer piston and hence improved linear guidance for the inner piston.

As a further development of the invention, the helical compression springs are supported on the outer piston. In this development, the inner piston thus provides the first operating stage with a low torque and a gently sloping pressure characteristic, before the supplementary engagement of the outer piston then takes place at a higher pressure level.

Further advantages and features of the invention will become apparent from the claims and from the following description of a preferred illustrative embodiment of the invention, which is explained with reference to the drawings.

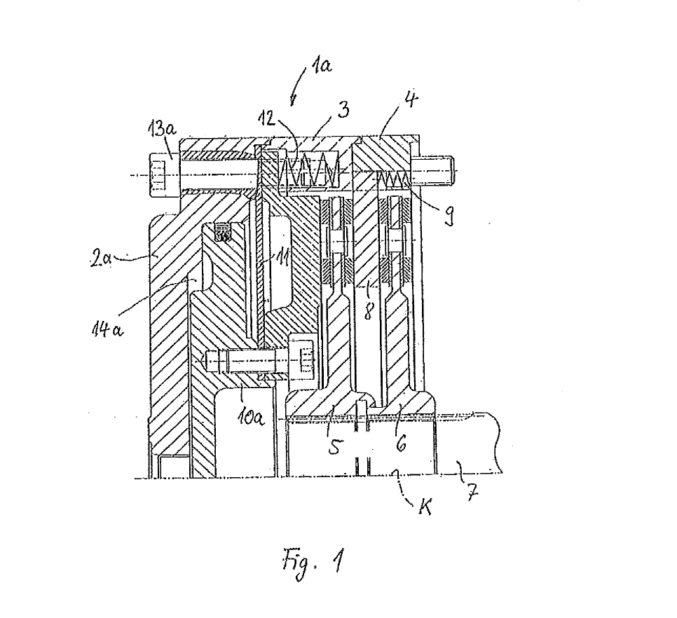

FIG. 1 shows one embodiment of a friction clutch of the kind known from the prior art, in a sectional representation,

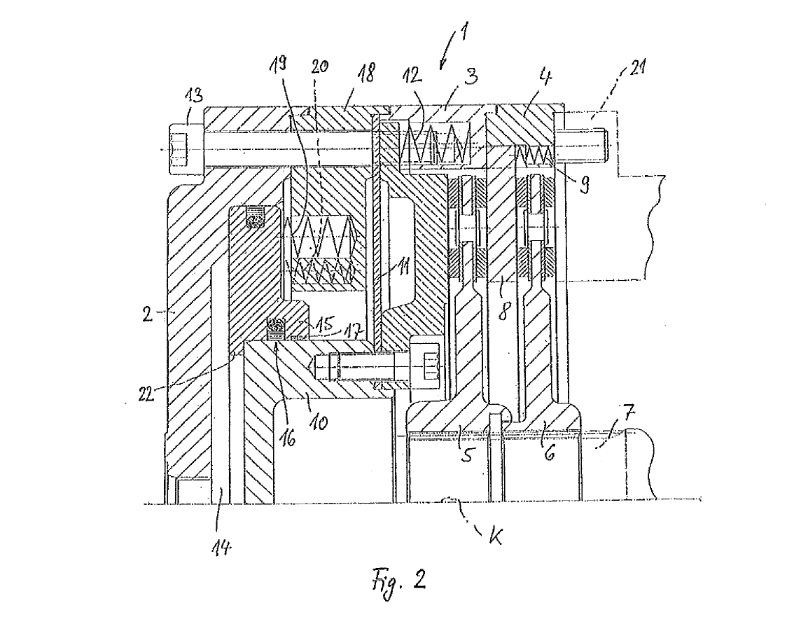

FIG. 2 shows one embodiment of a friction clutch according to the invention, and

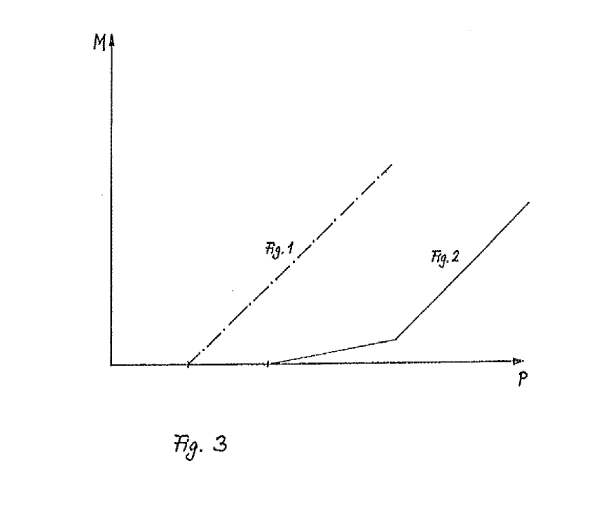

FIG. 3 shows a diagram of a pressure/torque response of the friction clutch according to FIG. 1, on the one hand, and of the friction clutch according to the invention according to FIG. 2, on the other hand.

A hydraulically actuated friction clutch 1 according to the invention, which is shown in FIG. 2, is provided for the purpose of engaging a main drive of a combine harvester. The main drive is indicated by a drive shaft 7 illustrated in chain-dotted lines. The friction clutch 1 according to the invention is described below in comparison with a friction clutch 1a in accordance with FIG. 1, of the kind known from the prior art. Identical components in the friction clutch 1 according to FIG. 2 and in the prior-art clutch 1a according to FIG. 1 are provided with identical reference signs. Parts and sections which function in the same way but are different in their specific structural embodiment are provided with the same reference signs, with the addition of the letter a for the prior-art clutch according to FIG. 1. The known friction clutch 1a in accordance with FIG. 1 will be explained first below.

The friction clutch 1a according to FIG. 1 has a multi-part clutch housing 2a, 3, 4, wherein the housing parts 2a, 3, 4 are connected to one another by screw fasteners 13a on the outer circumference of the friction clutch 1a. Arranged in the clutch housing is a pressure piston arrangement 10a, to which pressure can be applied hydraulically by means of a sealed pressure space 14a. The pressure piston arrangement 10a can be moved axially relative to the clutch housing 2a, 3, 4 along a clutch rotational axis K. Resetting is effected by a flexible disk diaphragm 11, which is secured radially on the inside on the pressure piston arrangement 10a and radially on the outside between housing parts 2a and 3. A pressure surface of the pressure piston arrangement 10a acts on a first friction disk 5, which is connected to the input hub 7 in a manner which allows axial movement but prevents relative rotation. A further friction disk 6 is arranged on the input hub 7 in a position axially offset from the first friction disk 5, said further friction disk likewise being supported on the input hub 7 in a manner which allows axial movement and prevents relative rotation. Arranged between the two friction disks 5, 6 is a pressure disk 8, which is arranged in a housing part 4 of the clutch housing 2a, 3, 4 in a manner which prevents relative rotation but allows axial movement. A return spring arrangement 9 is assigned to the spacing disk 8 and presses the pressure disk 8 against a housing stop of housing part 3 in the no-load initial position. The pressure piston arrangement 10a also acts on a return spring arrangement 12, which presses a piston section of the pressure piston arrangement 10a, said section bearing the piston pressure surface, against housing section 2a of the clutch housing and hence against the outer clamping arrangement of the disk diaphragm 11 in the no-load initial position. In the no-load initial position of the pressure piston arrangement 10a, both friction disks 5 and 6 are released since both the pressure piston arrangement 10a and the pressure disk 8 are held in the initial position thereof, on the left in FIG. 1, the former by the disk diaphragm 11 and the return spring arrangement 12 and the latter by the compression spring arrangement 9.

When hydraulic pressure is applied by appropriate filling of the pressure space 14a with hydraulic oil, the pressure piston arrangement 10a is moved axially to the right—in relation to the plane of the drawing in FIG. 1—as a result of which friction disk 5 is pressed against the pressure disk 8, and the latter, in turn, presses the second friction disk 6 against a section (not shown) of the main drive defined by the input hub 7. A diesel engine is connected directly or indirectly on the opposite side of the clutch. As soon as pressure is applied hydraulically to the pressure piston arrangement 10a and, as a result, there is an operating process of the friction clutch 1a, there is a very marked dip in the speed of the diesel engine, and this may even lead to stalling of the diesel engine.

In order to avoid this problem with the friction clutch 1a from the prior art, the friction clutch 1 according to the invention is provided, being of identical construction to the known friction clutch 1a in respect of the second side of the clutch, that assigned to the drive shaft 7. To avoid repetitions, attention is therefore drawn to the disclosure of the friction clutch 1a in accordance with FIG. 1.

The essential difference of the friction clutch 1 according to the invention shown in FIG. 2 is that the left hand side of the clutch in the drawing, namely the first side of the clutch, is constructed differently. In the friction clutch 1 according to the invention, the pressure piston arrangement 10a is embodied as a double piston, comprising an inner piston 10 and an outer piston 15. The inner piston 10 is of multi-part construction, similar to that of the pressure piston arrangement 10a according to FIG. 1, and has a piston section which acts on the first friction disk 5 and which comprises the corresponding piston end face. This piston section is connected by means of an axial screw fastener to an effective piston section, the frontal pressure surface of which faces-the pressure space 14. Radially on the inside, the disk diaphragm 11 used for the return action is clamped between the effective piston section and the piston section facing friction disk 5. Radially on the outside, the disk diaphragm 11 is clamped between housing section 13 and an intermediate housing section 18, which is part of the overall clutch housing.

The annular disk 6 facing the second side of the clutch is supported axially on a clutch section 21 of the main drive.

The pressure piston arrangement according to FIG. 2 furthermore comprises an annular outer piston 15, which is supported in housing part 2 of the clutch housing, coaxially with the inner piston 10. The effective piston section of the inner piston 10 is supported in the outer piston 15 in a manner which allows axial movement. The outer piston 15 has an annular shoulder 22 which projects radially inward and which forms an axial stop relative to the effective piston section of the inner piston 10. The inner piston 10 is sealed off relative to the outer piston 15 by means of a seal arrangement 16. Moreover, an annular sliding-contact strip 17 is provided as a sliding bearing between the inner piston 10 and the outer piston 15, serving as a guide strip for the axial mobility of the inner piston 10 relative to the outer piston 15. The annular sliding-contact strip 17 is fitted into a corresponding annular groove in the outer piston 15, said annular groove being opened radially toward the inside, and prevents metallic contact between the outer piston 15, which is composed of steel, and the inner piston 10, which is composed of steel. In the illustrative embodiment shown, the annular sliding-contact strip 17 is produced from PTFE.

The outer piston 15 is supported in housing part 2 of the clutch housing in a manner which allows sealed axial movement by means of a seal arrangement (not designated specifically). The intermediate housing part 18 projects radially between the outer piston 15 and the disk diaphragm 11, as can be seen from FIG. 2. Arranged in the intermediate housing part 18 is a helical compression spring arrangement 19, 20, which is made up of a plurality of helical compression springs arranged in a manner distributed around the circumference of the intermediate housing part 18. In this case, smaller helical compression springs 20 and larger helical compression springs 19 are provided, being arranged in the intermediate housing part 18 in a manner offset relative to one another radially and in the circumferential direction. The helical compression springs 19, 20 are arranged in axial recesses in the intermediate housing part 18, said recesses being open axially toward the outer piston 15. The helical compression springs 19, 20 are each supported, on the one hand, on a bottom of the respective axial recess in the intermediate housing part 18 and, on the other hand, on an end face of the outer piston 15 remote from the pressure space 14. The helical compression springs 19, 20 exert an axial counterforce on the outer piston 15, holding the outer piston 15 pressed against housing part 2 in the no-load initial position of the outer piston 15. The outer piston 15 has an effective piston surface within the pressure space 14 which ends in the region of the annular shoulder 22 radially on the inside. The inner piston 10 has an effective piston surface which adjoins the piston surface of the outer piston 15 radially on the inside. The total effective piston surface of the pressure space 14 is therefore formed jointly by the inner piston 10 and the outer piston 15. The effective piston surfaces of the outer piston 15 and the inner piston 10 are matched in such a way to the counterforces exerted by the compression spring arrangements 12 and 19, 20 that, as the application of hydraulic pressure begins within the pressure space 14, the inner piston 10 is moved axially first of all. It is only when the pressure increases further that the outer piston 15 also overcomes the counterforces produced by the compression spring arrangements 19, 20 and moves in the axial direction. By means of the annular shoulder 22, the outer piston 15 transmits the corresponding pressure forces to the inner piston 10, which, in turn, acts upon the friction disks 5 and 6. The supplementary pressure force of the outer piston 15 is defined by the effective piston surface thereof in the pressure space 14. Force transmission takes place via the annular shoulder 22 to the inner piston 10.

As already explained, the friction clutch 1 according to FIG. 2 corresponds to the friction clutch 1a according to FIG. 1 in respect of the clutch half on the right in the drawing. The clutch half on the left in the drawing according to FIG. 2 is formed by mutually separate components which are connected releasably to one another or to the other clutch parts. The clutch parts which differ as compared with the friction clutch 1a according to FIG. 1 are the intermediate housing part 18, the helical compression springs 19, 20, the inner piston 10, the outer piston 15, the guide strip 17 and the additional seal arrangement 16, as well as screw fasteners 13 of appropriately greater length. All these clutch parts can be attached releasably to the remaining parts identical to those in the friction clutch 1a according to FIG. 1 and can be connected by means of correspondingly releasable fastening means. This makes it possible to retrospectively convert a known friction clutch 1a according to FIG. 1 to a friction clutch 1 according to the invention as shown in FIG. 2 while using components of the known friction clutch. Retrospective conversion of a known friction clutch 1a to a friction clutch 1 according to the invention as shown in FIG. 2 is thereby made possible with relatively little outlay.

From FIG. 3, it can be seen how the friction clutch 1a according to FIG. 1 and the friction clutch 1 according to the invention as shown in FIG. 2 have a different pressure/torque response during operation. In the diagram shown in FIG. 3, the torque M is plotted on the ordinate and the pressure p is plotted on the abscissa. The pressure/torque characteristic of the friction clutch 1a according to FIG. 1 is shown in chain-dotted lines. The pressure/torque characteristic of the friction clutch 1 according to the invention as shown in FIG. 2 is indicated by a solid line. As can be seen from the diagram in FIG. 3, there is a two-stage engagement in friction clutch 1. In a first stage, during which the pressure forces of the helical compression springs 19, 20 still hold the outer piston 15 in the initial position thereof, there is only a slight rise in the torque for a corresponding increase in pressure. It is only when the resulting total effective piston area of both pistons of the double piston takes effect that there is the same rise in torque relative to the increase in pressure as in the friction clutch 1 according to FIG. 1 from the start.

1. A pressure-medium actuated friction clutch or brake having an axially movable pressure piston arrangement and at least one friction disk, to which pressure can be applied by the pressure piston arrangement, the pressure piston arrangement having at least two pistons which can be applied to the at least one friction disk in succession and in stages in a pressure-dependent manner, wherein the pressure piston arrangement is formed by a pair of pistons comprising an inner piston, which can be returned by a flexible disk diaphragm, and an annular outer piston radially surrounding the inner piston, wherein the inner piston is mounted slidably in the outer piston.

2. The pressure-medium actuated friction clutch or brake as claimed in claim 1, wherein the pistons are assigned a common pressure space for the application of pressure medium, and in that at least one piston is assigned a retention means which applies a counterforce and defines a higher pressure level for an axial movement of one piston than for the at least one other piston.

3. The pressure-medium actuated friction clutch or brake as claimed in claim 2, wherein at least one mechanical spring arrangement, which acts on the piston, is provided as the retention means.

4. The pressure-medium actuated friction clutch or brake as claimed in claim 2, wherein the retention means comprises a piston bearing with a friction coefficient which is higher than that of a bearing for the at least one other piston.

5. The pressure-medium actuated friction clutch or brake as claimed in claim 3, wherein the spring arrangement has a plurality of helical compression springs, which are arranged in a manner distributed over a clutch or brake circumference and engage, on the one hand, on a clutch or brake housing and, on the other hand, on a piston end face remote from the pressure space.

6. (canceled)

7. The pressure-medium actuated friction clutch or brake as claimed in claim 1, wherein a sliding bearing is provided between the outer piston and the inner piston, comprising a nonmetallic annular sliding-contact strip.

8. The pressure-medium actuated friction clutch or brake as claimed in claim 1, wherein the annular sliding-contact strip is composed of PTFE.

9. The pressure-medium actuated friction clutch or brake as claimed in claim 5,
wherein the helical compression springs are supported on the outer piston.
